(19) United States
(12) Patent Application Publication
(10) Pub. No.: US 2014/0314924 A1
(43) Pub. Date: Oct. 23, 2014

(54) FLAVORED DAIRY BEVERAGES HAVING A STABILIZING SYSTEM

(71) Applicant: NESTEC S.A., Vevey (CH)

(72) Inventors: Alexander A. Sher, Dublin, OH (US); Sandhya Sridhar, Danbury, CT (US); Stephen Mark, Dublin, OH (US); Ying Zheng, Dublin, OH (US); Jun-Tse Ray Fu, Dublin, OH (US)

(21) Appl. No.: 14/358,371

(22) PCT Filed: Nov. 2, 2012
(86) PCT No.: PCT/EP2012/071769

§ 371 Date: May 15, 2014

Related U.S. Application Data
(60) Provisional application No. 61/560,504, filed on Nov. 16, 2011.

(51) Int. Cl. A23C 3/08; A23C 9/156

(52) U.S. Cl. CPC A23C 3/08; A23C 9/156
USPC 426/330.2; 426/584

(57) ABSTRACT

Flavored dairy beverages having stabilizing systems and methods of making the flavored dairy beverages are disclosed herein. The flavored dairy beverages can have a reduced amount of sugar and be shelf-stable and aseptic. In a general embodiment, the dairy beverages comprise milk, a flavoring component, and a stabilizing system comprising a cellulose and carrageenan. The weight ratio of the cellulose to the carrageenan ranges from about 17:1 to about 1.5:1.

### BACKGROUND

The present disclosure generally relates to food products. More specifically, the present disclosure relates to flavored dairy beverages having a stabilizing system.

Dairy beverages having a flavoring such as chocolate or strawberry are popular drinks for consumers. However, conventional flavored dairy beverages tend to have high amounts of sugar, which can be unhealthy for a consumer. Unfortunately, flavored dairy beverages having a reduced amount of sugar are generally unstable and result in sedimentation, syneresis and phase separation when stored over time. A desired dairy low sugar, flavored dairy beverage should be shelf-stable during storage without phase separation, syneresis, gelation and sedimentation, and retain a constant viscosity over time.

### SUMMARY

The present disclosure relates to flavored dairy beverages having a stabilizing system and methods of making the flavored dairy beverages. The flavored dairy beverages can have a reduced amount of sugar and be shelf-stable and aseptic over an extended period of time. In a general embodiment, the present disclosure provides a beverage having milk, a flavoring component, and a stabilizing system including a cellulose and carrageenan. The weight ratio of the cellulose to the carrageenan can range from about 17:1 to about 1.5:1. The milk can be fat free milk, low fat milk, whole milk, powdered milk or a combination thereof.

In an embodiment, the weight ratio of the cellulose to the carrageenan ranges from about 8:1 to 2:1. In another embodiment, the weight ratio of the cellulose to the carrageenan ranges from about 7:1 to about 2:1.

In an embodiment, the cellulose includes about 10% to about 20% by weight carboxymethylcellulose and from about 80% to about 90% by weight microcrystalline cellulose. The carregeenan can be lambda carrageenan, kappa-carrageenan, iota carrageenan or a combination thereof.

In an embodiment, the flavoring component includes a sugar. The amount of sugar can range from about 0.1% to about 6% by weight. In this regard, the beverage can have a reduced amount of sugar (e.g., less than 6% by weight) compared to conventional flavored dairy beverages. Preferably, the sugar ranges from about 4% to about 6% by weight. In an embodiment, the weight ratio of the sugar:protein in the milk:cellulose ranges from (18-50):(15-30):1.

In an embodiment, the flavoring component includes a cocoa product. The cocoa product can be cocoa, white chocolate, milk chocolate, dark chocolate or a combination thereof. In another embodiment, the flavoring component includes a fruit flavoring. In another embodiment, the beverage and/or the flavoring component includes a sugarless sweetener.

In yet another embodiment, the present disclosure provides a method of providing a stable dairy beverage. The method comprises combining milk with a flavoring component, and a stabilizing system including a cellulose and carrageenan, wherein the weight ratio of the cellulose to the carrageenan ranges from about 17:1 to about 1.5:1. The method can further comprise homogenizing the beverage and/or aseptically processing the beverage.

In an alternative embodiment, the present disclosure provides a reduced sugar, aseptic, shelf-stable dairy beverage including milk such as fat free milk, low fat milk, whole milk, powdered milk or a combination thereof, sugar ranging from about 0.1% to about 6% by weight, a cocoa product, and a stabilizing system including a cellulose and carrageenan. The weight ratio of the cellulose to the carrageenan ranges from about 17:1 to about 1.5:1. The weight ratio of the sugar:protein in the milk:cellulose ranges from (18-50):(15-30):1.

An advantage of the present disclosure is to provide an aseptic, shelf-stable flavored dairy beverage.

Another advantage of the present disclosure to provide a stable flavored dairy beverage having a low sugar content.

Still another advantage of the present disclosure is to provide a method of making a stable dairy beverage.

Additional features and advantages are described herein and will be apparent from the following Detailed Description and the figures.

### BRIEF DESCRIPTION OF THE FIGURES

FIG. 1 shows the effect of the cellulose:carrageenan ratio on the degree of instability.

FIG. 2 shows the effect of the cellulose:carrageenan ratio on the product viscosity.

### DETAILED DESCRIPTION

The present disclosure relates to flavored dairy beverages having a stabilizing system and methods of making the flavored dairy beverages. The flavored dairy beverages can have a reduced sugar content compared to conventional flavored dairy beverages. The flavored dairy beverages are stable and overcome phase separation issues (e.g., gelation, syneresis, sedimentation, etc.) during long term storage. The flavored dairy beverages can have a shelf-life stability, for example, for at least 6 months, 7 months, 8 months, 9 months or longer at refrigeration temperatures. The flavored dairy beverages can be shelf-stable and aseptic. The flavored dairy beverages can also be chilled or refrigerated.

It has been surprisingly found that a stabilizing system including a cellulose and carrageenan can be used to provide a shelf-stable, flavored dairy beverage, especially dairy beverages having a reduced sugar content (e.g., less than 6%, 5%, 4%, 3%, 2% or 1% by weight). As used herein, the term “shelf-stable” means remaining in a state or condition having minimal phase separation (e.g., sedimentation, age gelation, syneresis) for an extended period of time (e.g., for at least 1, 2, 3, 4, 5, 6, 7, 8, 9, 10, 11, 12 months or more).

In a general embodiment, the present disclosure provides a beverage having milk, a flavoring component, and a stabilizing system including a cellulose and carrageenan. The weight ratio of the cellulose to the carrageenan can range from about 17:1 to about 1.5:1. More preferably, the weight ratio of the cellulose to the carrageenan ranges from about 8:1 to about 2:1 or from about 7:1 to about 2:1.

The milk can be in any suitable form including fat free milk, low fat milk, reduced fat milk, whole milk, powdered milk or a combination thereof. In general, milk fat content (by weight) could any number less as compare to that of whole milk.

The cellulose can be in the form of microcrystalline cellulose, carboxymethylcellulose (cellulose gum, cellulose gel) and the like or combinations thereof. In an embodiment, the cellulose includes about 10% to about 20% by weight carboxymethylcellulose and from about 80% to about 90% by weight microcrystalline cellulose. The carregeenan can be lambda carrageenan, kappa-carrageenan, iota carrageenan or a combination thereof.

In an embodiment, the flavoring component includes a sugar. The amount of sugar can range from about 0.1% to about 6% by weight. In this regard, the beverage can have a reduced amount of sugar (e.g., less than 6% by weight) compared to conventional flavored dairy beverages. Preferably, the sugar ranges from about 4% to about 6% by weight. In an embodiment, the weight ratio of the sugar:protein in the milk:cellulose ranges from (18-50):(15-30):1.

In an embodiment, the flavoring component can comprise any suitable sweeteners including, for example, sucrose, fructose, dextrose, maltose, dextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination.

In an embodiment, the flavoring component includes a flavor such as a cocoa product, a fruit flavoring or a combination thereof. The cocoa product can be cocoa, white chocolate, milk chocolate, dark chocolate or a combination thereof. The fruit flavoring can be strawberry, banana, etc.

Usage level of the flavors and/or sweeteners may vary greatly and will depend on such factors as potency of the sweetener, desired sweetness of the product, level and type of flavor used and cost considerations. Combinations of sugar and/or sugarless sweeteners may be used in the flavored dairy beverages.

In another embodiment, the present disclosure provides a method of providing a stable dairy beverage. The method comprises combining milk with a flavoring component, and a stabilizing system including a cellulose and carrageenan, wherein the weight ratio of the cellulose to the carrageenan ranges from about 17:1 to about 1.5:1, preferably about 8:1 to about 2:1 or about 7:1 to about 2:1. The method can further comprise homogenizing the beverage and/or aseptically processing the beverage. The stable dairy beverage can have a reduced amount of sugar (e.g., less than 6% by weight) compared to conventional flavored dairy beverages.

During processing and production of the flavored dairy beverages, the hydration of any components of the flavored dairy beverages such as the sweetener(s) and flavor(s) in milk can be done under agitation followed by heat treatment, homogenization, cooling and filling aseptic containers under aseptic conditions. Aseptic heat treatment may use direct or indirect ultra high temperature (“UHT”) processes. UHT processes are known in the art. Examples of UHT processes include UHT sterilization and UHT pasteurization.

Direct heat treatment is performed by injecting steam water in the emulsion. In this case, it may be necessary to remove excess water, by flashing. Indirect heat treatment is performed with a heat transfer interface in contact with the emulsion. The homogenization could be performed before and/or after heat treatment. It may be interesting to perform homogenization before heat treatment in order to improve heat transfers in the emulsion, and thus achieve an improved heat treatment. Performing a homogenization after heat treatment usually ensures that the oil droplets in the emulsion have the desired dimension. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 B1 to Taggart, which are incorporated herein by reference.

### EXAMPLES

By way of example and not limitation, the following examples are illustrative of various embodiments of the present disclosure.

### Example 1

Table 1 shows a range of ingredients for a “reduced” sugar dairy beverage formula according to an embodiment of the present disclosure.

TABLE 1
“Reduced sugar” recipes*

| Ingredient | % by weight |
|---|---|
| Milk solid non-fat (“MSNF”) | 8-10 |
| Milk Fat | 0-3.5 |
| Sugar | 4-5.9 |
| Cocoa Powder | 0-1.5 |
| Cellulose gel/cellulose gum | 0.08-0.6 |
| Carrageenan | 0.005-0.1 |
| Water | remainder |
| Total input ingredients | 100.00 |

*Addition of other flavors is optional.

### Example 2

A “full” sugar dairy beverage formulation is shown in Table 2. The “full” sugar dairy beverage formulation shows good physico-chemical stability (e.g., no phase separation).

TABLE 2
Example of “Full sugar” formula

| Ingredient | % by weight |
|---|---|
| MSNF | 8 |
| Milk Fat | 1 |
| Sugar | 7 |
| Cocoa Powder | 0.5 |
| Cellulose gel/cellulose gum | 0.18 |
| Carrageenan | 0.01 |
| Water | remainder |
| Total input ingredients | 100.00 |

### Example 3

Table 3 shows a “reduced” sugar dairy beverage formulation (all the same ingredients as Table 2 but lower sugar level) without the stabilizing system. The reduced sugar dairy beverage shows bad physico-chemical stability (e.g., phase separation).

TABLE 3
Example of “reduced sugar” formula without the stabilizing system

| Ingredient | % |
|---|---|
| MSNF | 8 |
| Milk Fat | 1 |
| Sugar | 5 |
| Cocoa Powder | 0.5 |
| Cellulose gel/cellulose gum | 0.18 |
| Carrageenan | 0.01 |
| Water | remainder |
| Total input ingredients | 100.00 |

### Example 4

Table 3 shows a “reduced” sugar dairy beverage formulation (all the same ingredients but with the stabilizing system ratio). The sugar dairy beverage formulation with the stabilizing system shows good physico-chemical stability (e.g., no phase separation).

TABLE 4
Example of “reduced sugar” formula having the stabilizing system

| Ingredient | % |
|---|---|
| MSNF | 8 |
| Milk Fat | 1 |
| Sugar | 5 |
| Cocoa Powder | 0.5 |
| Cellulose gel/cellulose gum | 0.14 |
| Carrageenan | 0.03 |
| Water | remainder |
| Total input ingredients | 100.00 |

### Example 5

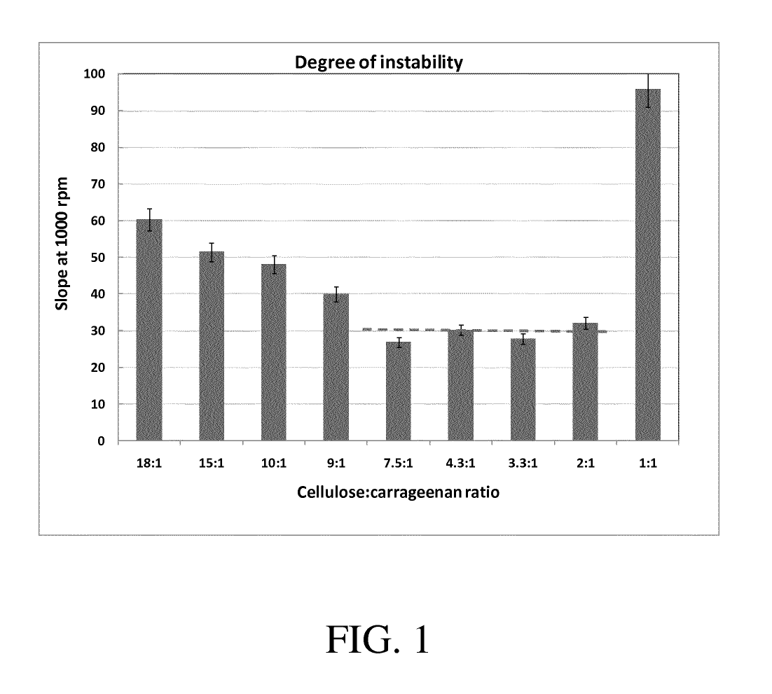

Additional data supported the optimal ratio between cellulose and carrageenan that provides stability in a “reduced” sugar dairy beverage formulation. Based on the results on a stability evaluation (centrifugation/light scattering techniques) of the formulation with a reduced level of sugar of Example 3, the first proposed cellulose:carrageenan weight ratio of 8:1 to 2:1 was good for stabilization. FIG. 1 shows the effect of the cellulose:carrageenan weight ratio on degree of instability. Generally, a cellulose:carrageenan weight ratio can also range from 17:1 to 1.5:1 (see FIG. 1.) where the degree of the suspension instability was found to be low (the lower slope, the more stable is the system).

In addition, the instability index for samples in this range (17:1 to 1.5:1) was similar to that for the samples without reduced sugar, which have stable emulsions during the product shelf-life. Thus, the preferred formulations are covered by the cellulose:carrageenan weight ratio ranging from about 17:1 to about 1.5:1. More preferred formulations are covered by the cellulose:carrageenan weight ratio ranging from about 8:1 to about 2:1 or from about 7:1 to about 2:1.

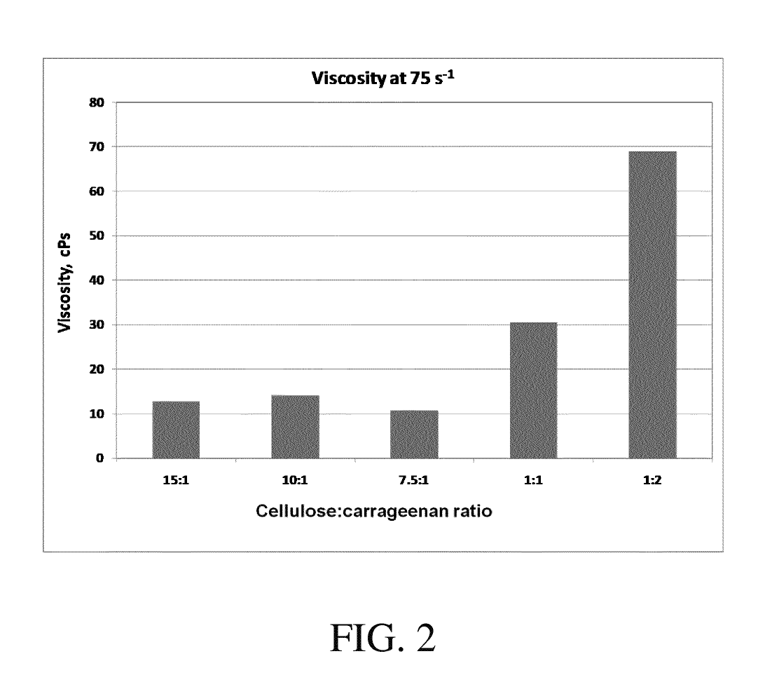

FIG. 2 shows the effect of the cellulose:carrageenan weight ratio on product viscosity. It was surprisingly found that samples with higher viscosities (weight ratio 1:1 and 1:2) were less stable (See FIG. 2) because, in general, higher viscosities lead to higher physico-chemical stability of beverages. As a result, the mechanism of stabilization in the reduced sugar beverages is complex and includes stabilization by interactions within the hydrocolloid systems in the specific cellulose:carrageenan weight ratios as well as with milk proteins in the specific protein:cellulose:carrageenan ratios. The mechanism cannot be explained merely by the changes in the product viscosity.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A beverage comprising:
milk;
a flavoring component; and
a stabilizing system comprising a cellulose and carrageenan, the weight ratio of the cellulose to the carrageenan is from about 17:1 to about 1.5:1.

2. The beverage of claim 1, wherein the weight ratio of the cellulose to carrageenan is from about 8:1 to 2:1.

3. The beverage of claim 1, wherein the weight ratio of the cellulose to the carrageenan is from about 7:1 to about 2:1.

4. The beverage of claim 1, wherein the cellulose comprises about 10% to about 20% by weight carboxymethylcellulose and from about 80% to about 90% by weight microcrystalline cellulose.

5. The beverage of claim 1, wherein the carregeenan is selected from the group consisting of lambda carrageenan, kappa-carrageenan, iota carrageenan and combinations thereof.

6. The beverage of claim 1, wherein the flavoring component comprises a sugar.

7. The beverage of claim 6, wherein the amount of sugar ranges from about 0.1% to about 6% by weight.

8. The beverage of claim 6, wherein the weight ratio of the sugar:protein in the milk:cellulose is from (18-50):(15-30):1.

9. The beverage of claim 1, wherein the beverage is aseptic.

10. The beverage of claim 1, wherein the flavoring component comprises a cocoa product.

11. The beverage of claim 10, wherein the cocoa product is selected from the group consisting of cocoa, white chocolate, milk chocolate, dark chocolate and combinations thereof.

12. A method of providing a stable dairy beverage, comprising:
combining milk with a flavoring component, and a stabilizing system comprising a cellulose and carrageenan, wherein the weight ratio of the cellulose to the carrageenan is from about 17:1 to about 1.5:1.

13. The method of claim 12 further comprising homogenizing the beverage.

14. The method of claim 12 comprising aseptically processing the beverage.

15. The method of claim 1, wherein the cellulose comprises about 10% to about 20% by weight carboxymethylcellulose and from about 80% to about 90% by weight microcrystalline cellulose.
